(19) United States
(12) Patent Application Publication
(10) Pub. No.: US 2025/0113288 A1
(43) Pub. Date: Apr. 3, 2025

(54) SMART BSS-COLORING TO OVERCOME CO-CHANNEL-INTERFERENCE (CCI) FOR WI-FI6

(71) Applicant: Fortinet, Inc., Sunnyvale, CA (US)

(72) Inventors: Shrikant Gambheer Patil, Sunnyvale, CA (US); Ruchir Mishra, Sunnyvale, CA (US)

(73) Assignee: Fortinet, Inc., Sunnyvale, CA (US)

(21) Appl. No.: 18/375,500

(22) Filed: Sep. 30, 2023

(51) Int. Cl. H04W 48/16; H04W 24/08; H04W 24/10

(52) U.S. Cl. CPC H04W 48/16; H04W 24/08; H04W 24/10

(57) ABSTRACT

Scan reports are received by a Wi-Fi controller from a plurality of access points. Each scan report identifies neighboring BSSIDs with associated BSS-color within radio range and corresponding RSSI measurements. An OBSS can be detected by cross referencing scan reports. BSS color us modified to avoid a potential BSS collision. A station associated the potential BSS collision reports actual color collisions. An indication of the BSS color change is transmitted to one or more access points for local implementation.

### FIELD OF THE INVENTION

The invention relates generally to computer networks, and more specifically, to proactive use of scan reports of surrounding blind service set identifiers (BSSIDs) to change BSS-colors for overlapping BSS (OBSS) radio ranges, prior to detecting related color collisions in OBSS.

### BACKGROUND

BSS-Colouring is a prominent feature introduced from 11AX standard (onwards), that brings many advances in OBSS (Overlapping BSS) deployments by reducing CCI (co-channel-interference).

The design of this feature in WiFi-6, WiFi-6E, WiFi-7 is based on the scenario where a wireless station detects a BSS-colour collision and reports the same to an access point. In response, the access point changes a corresponding BSS-color in order to have two OBSS broadcast over two different colors.

Problematically, this takes a lot of processing time at a station to make these complex calculations and finally send out a report to an access point for a response. Until the time a color collision is resolved by the access point, the connected stations suffer and have to mandatorily perform CSMA-CA and random-back-off algorithm (unable to transmit at higher data-rates). For example, if a 6 GHz capable station connected to WiFi-6E FAP (with BSSID color 1) starts to see a new BSSID with color1, it will consider it as inter-BSS and if frame color or color bit is same, then it will be considered as intra-BSS frame and station will have to contend for the medium as normal process. If the color is different, then the frame is considered an inter-BSS transmission from an OBSS, and deferral may not be necessary for the listening radio.

From the above study one thing is pretty clear that the process of detecting an existing colour-collision before/during/after association to AP is a tedious, battery consuming and time-taking (even when time is measured in ms) task for wireless stations.

Adds an additional overhead on their chipsets and more importantly forces them to fall back to CSMA-CA (random-back off-algorithm) in order to gain access to the medium and to be able to transmit back at higher data-rates.

What is needed is a robust technique for proactive use the AP-scan-list (for 2.4 GHZ, 5 GHZ and 6 GHz) of surrounding BSSIDs to smartly allocate unique BSS-color to various BSSIDs and quickly adapt/change BSS-color (when required) before station-reporting a detected color-collision.

### SUMMARY

To meet the above-described needs, methods, computer program products, and systems for proactive use of scan reports of surrounding blind service set identifiers (BSSIDs) to change BSS-colors for overlapping BSS (OBSS) radio ranges, prior to detecting related color collisions in OBSS.

In one embodiment, scan reports are received from a plurality of access points. Each scan report identifies neighboring BSSIDs with associated BSS-color within radio range and corresponding radio signal strength indicator (RSSI) measurements. An OBSS can be detected by cross referencing scan reports.

In another embodiment, a BSS color us modified to avoid a potential BSS collision. A station associated the potential BSS collision reports actual color collisions. An indication of the BSS color change is transmitted to one or more access points for local implementation.

Advantageously, computer networking is improved with fewer collisions and CCI while improving battery life for stations.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a network system for proactive use of scan reports of surrounding blind service set identifiers (BSSIDs) to change BSS-colors for overlapping BSS (OBSS) radio ranges, prior to detecting related color collisions in OBSS, according to one embodiment.

FIG. 2 is a more detailed block diagram illustrating a Wi-Fi controller of the system of FIG. 1, according to one embodiment.

FIG. 3 is a more detailed block diagram illustrating an access point of the system of claim 1, according to an embodiment.

FIG. 4 is a high-level flow chart for proactive use of scan reports of surrounding blind service set identifiers (BSSIDs) to change BSS-colors for overlapping BSS (OBSS) radio ranges, prior to detecting related color collisions in OBSS, according to an embodiment.

FIG. 5 is a block diagram illustrating an example computing device implementing the network system of FIG. 1, according to one embodiment.

### DETAILED DESCRIPTION

Methods, computer program products, and systems for proactive use of scan reports of surrounding blind service set identifiers (BSSIDs) to change BSS-colors for overlapping BSS (OBSS) radio ranges, prior to detecting related color collisions in OBSS. One of ordinary skill in the art will recognize many alternative embodiments that are not explicitly listed based on the following disclosure.

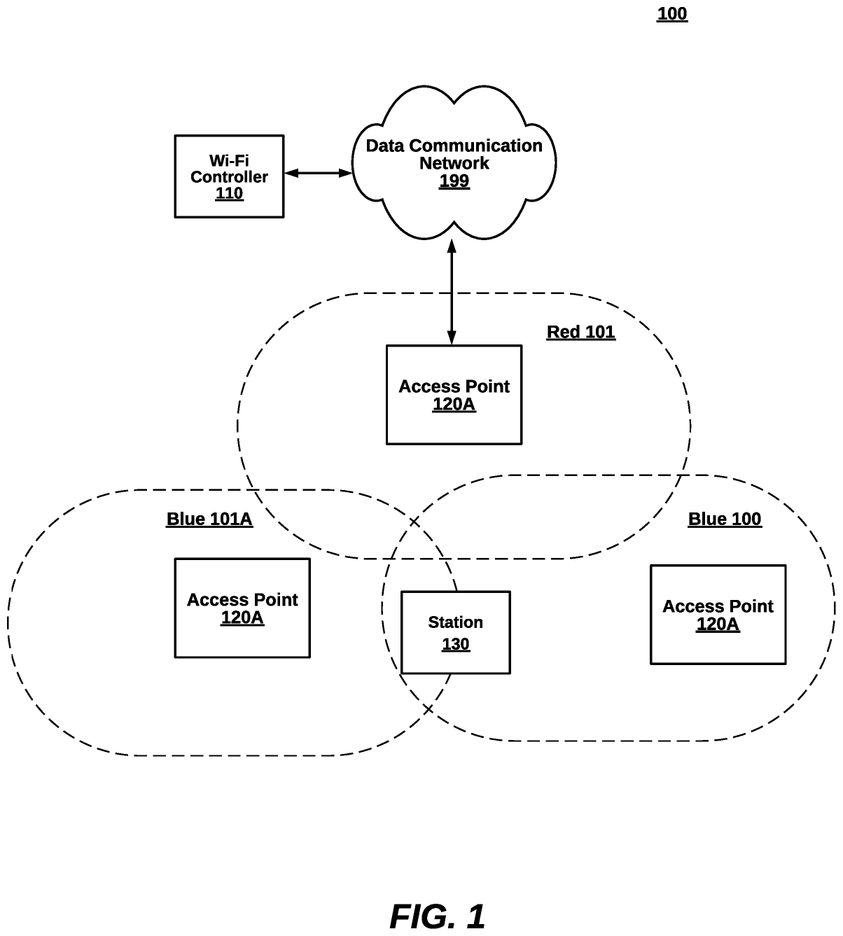

### I. Systems for Preventing OBSS Collisions (FIGS. 1-3)

FIG. 1 is a high-level block diagram illustrating a network system 100 for proactive use of scan reports of surrounding blind service set identifiers (BSSIDs) to change BSS-colors for overlapping BSS (OBSS) radio ranges, prior to detecting related color collisions in OBSS, according to one embodiment. The network system 100 includes a Wi-Fi controller 110, access points 120A-C and a station 130. Other embodiments of the system 100 can include additional components that are not shown in FIG. 1, such as controllers, network gateways, routers, switches, additional access points (Wi-Fi 6E access points and others), and wired or wireless stations (Wi-Fi 6E stations and others). Many variations are possible. The components are implemented in hardware, software, or a combination of both, as shown in the example below of FIG. 6.

The data communication network 199 can be composed of any data communication network such as an SDWAN, an SDN (Software Defined Network), WAN, a LAN, the Internet, WLAN, a cellular network (e.g., 3G, 4G, 5G or 6G), or a hybrid of different types of networks. Various data protocols can dictate format for the data packets. For example, Wi-Fi data packets can be formatted according to IEEE 802. 11, IEEE 802, 11r, 802.11be, Wi-Fi 6, Wi-Fi 6E, Wi-Fi 7 and the like. Components can use IPv4 or IPv6 address spaces. The deception server 110 can be coupled to a data communication network 199 such as a private network connected to the Internet. The deception appliance 120 can be connected to the data communication system both via hard wire (e.g., Ethernet) through an access point and/or a gateway device.

The Wi-Fi controller 110 preemptively resolves BSS-color conflicts before actual collisions are reported by stations. The access points 120A-C use BSS-colors within an RF range and also listen to BSS-colors nearby for analysis. The station 130, conventionally sends BSS-color collision reports, but in a preferred embodiment need not even be present because access points report data for preemptively changing BSS-colors where an overlap in RF ranges exists, causing CCI.

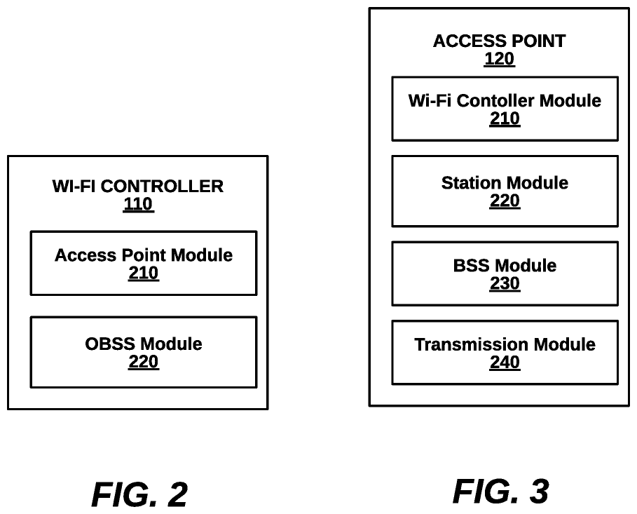

FIG. 2 is a more detailed block diagram illustrating the Wi-Fi controller 110 of FIG. 1, according to an embodiment. The Wi-Fi controller 110 includes a access point module 210, an OBSS module 220, an OT device profile database 230, and a transmission module 240. Components can be implemented in software and/or software. Many other variations of components are possible.

The access point module 210 can receive scan reports from a plurality of access points, wherein each scan report identifies neighboring BSSIDs with associated BSS-color within radio range and corresponding radio signal strength indicator (RSSI) measurements.

The OBSS module 220 detects a same color to identify OBSS. ABSS color is modified to avoid a potential BSS collision, wherein a station associated the potential BSS collision reports color collisions. An indication is sent to the one or more of the plurality access points of the modified BSS color.

FIG. 3 is a more detailed block diagram illustrating the access point 120 (representative of access points 120A-C) of FIG. 1, according to an embodiment. The access point 120 includes a Wi-Fi controller module 210 for sending scan reports upstream and receiving color notifications downstream. A station module 220 connects stations on the enterprise network and receives any CCI reports of collisions from stations. Reports of BSS-color interference should not be received if the proactive process described herein are successful. A BSS module 230 gather data from BSSs that are overheard from other access point along with extracted BSS-color information and RSSI. A transmission module 240 can include hardware and protocol software for receiving data packets including BSS-color information with in the headers. Components can be implemented in software and/or software. Many other variations of components are possible.

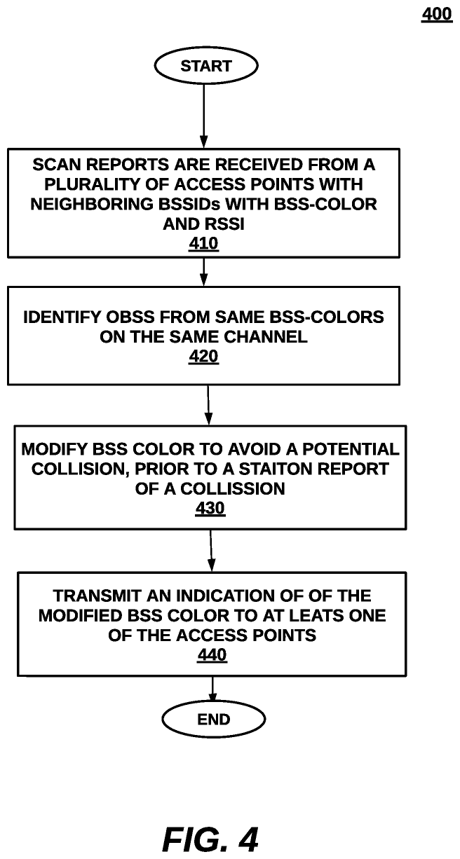

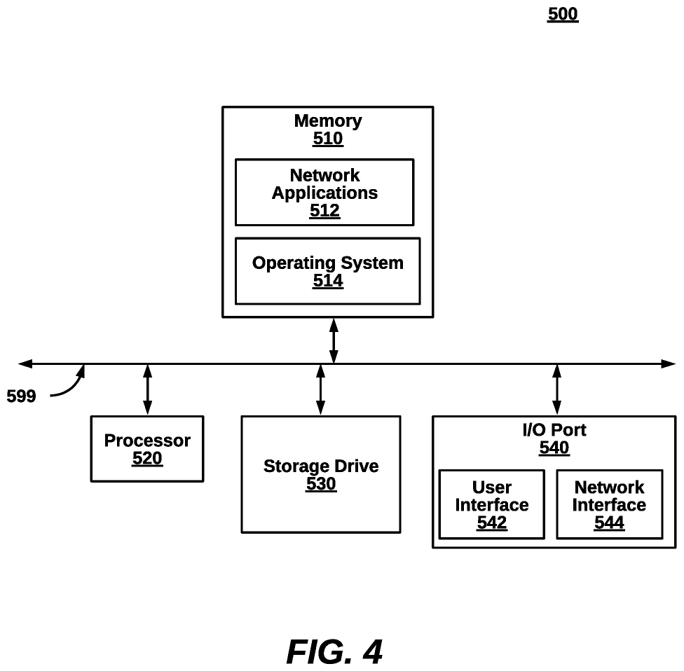

### II. Methods for Preventing OBSS Collisions (FIGS. 4)

FIG. 4 is a high-level flow diagram illustrating a method 400 for proactive use of scan reports of surrounding BSSIDs to change BSS-colors for OBSS radio ranges, prior to detecting related color collisions in OBSS, according to an embodiment. The method 400 can be implemented by, for example, system 100 of FIG. 1.

At step 410, scan reports are received from a plurality of access points. Each scan report identifies neighboring BSSIDs with associated BSS-color within radio range and corresponding radio signal strength indicator (RSSI) measurements.

At step 420, an OBSS is identified by same colors BSSs.

At step 430, a BSS color is modified to avoid a potential BSS collision. A station associated the potential BSS collision reports color collisions.

At step 440, an indication is transmitted to the one or more of the plurality access points of the modified BSS color.

### III. Computing Device for Preventing OBSS Collisions (FIG. 5)

FIG. 5 is a block diagram illustrating a computing device 500 implementing the packet processor 100 of FIG. 1, according to one embodiment. The computing device 500 is a non-limiting example device for implementing each of the components of the system 100, including the Wi-Fi 5E access point 110, access points 120A-C and Wi-Fi 5E station 130. Additionally, the computing device 500 is merely an example implementation itself, since the system 100 can also be fully or partially implemented with laptop computers, tablet computers, smart cell phones, Internet access applications, and the like.

The computing device 500, of the present embodiment, includes a memory 510, a processor 520, a hard drive 530, and an I/O port 540. Each of the components is coupled for electronic communication via a bus 550. Communication can be digital and/or analog, and use any suitable protocol.

The memory 510 further comprises network access applications 512 and an operating system 514. Network access applications can include 512 a web browser, a mobile access application, an access application that uses networking, a remote access application executing locally, a network protocol access application, a network management access application, a network routing access applications, or the like.

The operating system 514 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, OR Windows 7-11), Linux, HP-UX, UNIX, Sun OS, Solaris, Mac OS X, Alpha OS, AIX, IRIX32, or IRIX84. Other operating systems may be used. Microsoft Windows is a trademark of Microsoft Corporation.

The processor 520 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 520 can be single core, multiple core, or include more than one processing elements. The processor 520 can be disposed on silicon or any other suitable material. The processor 520 can receive and execute instructions and data stored in the memory 510 or the hard drive 530.

The storage device 530 can be any non-volatile type of storage such as a magnetic disc, EEPROM, Flash, or the like. The storage device 530 stores code and data for access applications.

The I/O port 540 further comprises a user interface 542 and a network interface 544. The user interface 542 can output to a display device and receive input from, for example, a keyboard. The network interface 544 connects to a medium such as Ethernet or Wi-Fi for data input and output. In one embodiment, the network interface 544 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C #, Oracle® Java, Javascript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

We claim:

1. A method in a Wi-Fi controller for proactive use of scan reports of surrounding blind service set identifiers (BSSIDs) to change BSS-colors for overlapping BSS (OBSS) radio ranges, prior to detecting related color collisions in OBSS, the method comprising the steps:
receiving scan reports from a plurality of access points, wherein each scan report identifies neighboring BSSIDs with associated BSS-color within radio range and corresponding radio signal strength indicator (RSSI) measurements;
identifying OBSS by detecting matching BSS-colors on a common channel;
modifying a BSS color to avoid a potential BSS collision, wherein a station associated the potential BSS collision reports color collisions; and
transmitting an indication one or more of the plurality access points of the modified BSS color.

2. The method of claim 1, wherein the BSS-color is one of: blue, red, white, yellow and orange.

3. The method of claim 1, wherein the access point comprises at least one of: a Wi-Fi 6 access point, a Wi-Fi 6E access point, and a Wi-Fi 7 access point.

4. The method of claim 1, wherein no stations are connected to any of the plurality of access points to send a station-based collision report.

5. A non-transitory computer-readable medium storing computer-readable instructions in a deception server on a data communication network, that when executed by a processor, perform a method for proactive use of scan reports of surrounding blind service set identifiers (BSSIDs) to change BSS-colors for overlapping BSS (OBSS) radio ranges, prior to detecting related color collisions in OBSS, the method comprising:
receiving scan reports from a plurality of access points, wherein each scan report identifies neighboring BSSIDs with associated BSS-color within radio range and corresponding radio signal strength indicator (RSSI) measurements;
identifying OBSS by detecting matching BSS-colors on a common channel;
modifying a BSS color to avoid a potential BSS collision, wherein a station associated the potential BSS collision reports color collisions; and
transmitting an indication one or more of the plurality access points of the modified BSS color.

6. A Wi-Fi controller on a data communication network, for proactive use of scan reports of surrounding blind service set identifiers (BSSIDs) to change BSS-colors for overlapping BSS (OBSS) radio ranges, prior to detecting related color collisions in OBSS, the Wi-Fi controller comprising:
a processor;
a network communication module, communicatively coupled to the processor and to the data communication network; and
a memory, communicatively coupled to the processor and storing:
an access point module to receive scan reports from a plurality of access points, wherein each scan report identifies neighboring BSSIDs with associated BSS-color within radio range and corresponding radio signal strength indicator (RSSI) measurements;
an OBSS module to identify OBSS by detecting matching BSS-colors on a common channel,
wherein the OBSS module to modify a BSS color to avoid a potential BSS collision, wherein a station associated the potential BSS collision reports color collisions; and
a transmission module to send an indication one or more of the plurality access points of the modified BSS color.
